(19) United States
(12) Patent Application Publication
(10) Pub. No.: US 2023/0067549 A1
(43) Pub. Date: Mar. 2, 2023

(54) FLOATING GENERATOR THAT HARNESSES THE ENERGY FROM WAVES TO PRODUCE USABLE ELECTRICAL ENERGY

(71) Applicant: David Zielinski, Pompano, FL (US)

(72) Inventor: David Zielinski, Pompano, FL (US)

(21) Appl. No.: 17/896,899

(22) Filed: Aug. 26, 2022

Related U.S. Application Data
(60) Provisional application No. 63/237,317, filed on Aug. 26, 2021.

(51) Int. Cl. F03B 13/14; F04B 23/02; B01D 61/02; B01D 61/10; C02F 1/44

(52) U.S. Cl. CPC F03B 13/14; F04B 23/02; B01D 61/025; B01D 61/10; C02F 1/441; B01D 2313/367; C02F 2103/08

(57) ABSTRACT

A wave-powered floating water pump apparatus comprises a housing operatively connected to a piston capable of reciprocating therein, and an exterior float. The housing interior defines a compression chamber including a compression chamber back valve. The compression chamber back valve opens when the apparatus descends in the ocean, and closes when the float lifts the apparatus. The piston comprises a piston shaft with a piston back valve therein, constructed and arranged to permit water which enters the piston shaft in response to water pressure from the compression chamber only to exit the top of the piston shaft at a higher elevation. A floating generator system for harnessing energy from ocean waves to produce usable electrical energy may include the pump, a water storage reservoir and a hydro-turbine. A system for purifying and desalinating water may include the pump, a semi-permeable membrane for reverse osmosis and a reservoir for purified water.

### CROSS-REFERENCE TO RELATED APPLICATION

This application claims the benefit of U.S. Provisional Patent Application 63/237,317 filed on Aug. 26, 2021, which is incorporated by reference herein in its entirety.

### FIELD OF THE INVENTION

The present invention relates generally to generators, and more particularly to a floating generator that harnesses the energy from ocean waves to produce usable electrical energy.

### BACKGROUND OF THE INVENTION

An ongoing need exists for generators which provide renewable sources of power. There is increasing interest in renewable energy, such as, for example without limitation, solar, wind, wave and tidal power. No current solutions provide an effective way to produce and deliver renewable energy at an economic price.

Ocean and tidal currents are a viable source of clean, renewable energy. Converting wave and tidal energy to a power source may benefit many areas of the world. There have been many proposals for converting wave or tidal flows into electricity as a non-polluting approach to power generation.

While previous solutions for harnessing water energy have been developed, many solutions focus on tidal energy rather than wave energy. Such solutions focus on tidal power, claiming various purported advantages over wave power devices, such as 1) claiming that tides are regular and predictable, whereas wave power depends essentially upon weather conditions; and 2) claiming that tidal power devices enable less complex structures because coastal site locations for tidal devices are generally exposed to less extreme weather so that the devices do not have to be constructed to the same level of survivability as ocean wave power devices.

Other previous solutions for harnessing “water power” as energy sources have typically involved water storage systems that are unable to meet current energy needs. Such storage systems may include dams, levies, basins, wells and reservoirs.

Previously attempted solutions for water based renewable energy systems appear to include systems for distributing water between interconnected reservoirs, recycling the water between two or more huge reservoirs to generate electrical power. However, this type of solution requires complex structures. This type of solution also requires the use of a traditional hydroelectric facility which would not be economically feasible for many underdeveloped parts of the world.

Some solutions provide systems for generating power which appear to include a barrier partially dividing a body of water subject to tidal effects into two regions of water such that said regions of water have differing water levels over a tidal cycle. A passage is provided in the barrier for placing the regions of water in fluid communication with each other, and means are also provided within said passage responsive to flow of water for driving a power generator. Water flows from one of the regions of water to the other of the regions of water via said passage when the regions have differing water levels during a tidal cycle. However, this type of solution also requires complex structures.

Another previous solution appears to provide a hydroelectric generating system coupled to a primary tidal reservoir through a bi-directional tideway to power a primary turbine as a diurnal cycle tide waxes and wanes. A secondary tidal reservoir includes a tideway and secondary turbine with flow modulated by a graduated control of a sluice gate to proportionately blend reserve tidewater capacity of the secondary tidal reservoir as a delayed resource of virtual tidal influx and reflux. An aggregate summation of tidal energy acting upon the turbine driven generators delivers a constant flow of electric power throughout the diurnal tidal cycle. Shunting excess tidal energy around the turbines during periods of reduced power-demand supplements tidal resources in subsequent phases of the diurnal tidal day when solar-day related power-demand may increase. This type of solution also requires complex structures.

Another proposed solution may provide a water-based renewable energy systems with a water wheel/weir assembly to provide pumping power for the systems. A water wheel powered pump and associated piping are used to raise water from a lower lake reservoir to a higher storage lake reservoir. The water which is pumped to the higher storage lake can be released to a generator located at a lower elevation and then returned to the lower storage lake. The cycle can then be repeated by again pumping water from the lower lake to the upper lake. The pumped storage provides flow and head to generate electric power through the turbine generator. However, this type of solution requires complex structures. This exemplifies the type of solution that would not be economically feasible for many underdeveloped parts of the world.

Other previous solutions provide extremely complicated power generating systems with pontoons. For example, a complicated tidal power apparatus includes a moored pontoon having a duct therethrough opening at opposed ends of the pontoon, the duct having a vertical axis rotor therein driving an electrical generator. A deflector vane is located in the duct at each end thereof, each deflector vane being mounted to pivot about a vertical axis between an active position, in which the deflector vane deflects water flow to one side of the rotor axis to cause rotation of the rotor, and an inactive position substantially aligned with the water flow from the turbine. Another proposed solution provides a wave generator power plant for converting energy from sea waves into electricity which utilizes a buoyant, moving, semi-submerged, cone-shaped pontoon that is powered by the sea wave motion to reciprocate within an anchored ring-pontoon. The reciprocation is changed to rotary motion by a connecting rod and crankshaft. Then, through a gearbox, the rotary motion drives an electrical generator. The fully submerged, stationary, buoyant, ring-pontoon must be anchored to the sea floor by sixteen (16) cables. Also, sixteen (16) columns connecting to it, support an upper above-water structure. Optimum operation takes place in sea waves of adequate height and period that can lift and drop the moving cone-shaped pontoon relative to the design mechanical requirements. Sea wave energy, through the design of this invention, is amassed to develop sixteen hundred (1600) horsepower and generate one ((1) mega-watt of electricity. Such solutions not only require complex structures, but also are dependent on the weather to generate adequate sea waves for the complicated structure to work.

Some other ocean energy extraction solutions have included anchored energy generating devices where the relative motion between a rigidly anchored component and a wave-driven flap is used to drive a generator, the use of near-shore water currents that are tunneled to ducted turbines, and devices that convert wave motion to vibration to electrical power that is then “harvested” by piezo-vibration devices. These types of solutions for energy-extracting have limitations due to the need for anchoring, specific location and limited performance and efficiency. The requirement for operation in open sea where marine energy may be insufficient to drive prior art devices sets a limit to the efficiency and performance level of existing energy-extraction systems. Additionally, the depth in open sea complicates the deployment of a buoy if rigid anchoring to the sea floor is required.

Electrical energy harvesting buoy assemblies with multiple floats have been attempted but have not effectively extracted energy from the surface of the sea. One solution proposed a free-floating ocean energy extraction buoy to produce electrical power by a wave-energy extraction method, including a wave-powered air pump incorporated into the energy-harvesting buoy physical design, and the mechanical drive mechanism of the above-air pressurization means in cooperation with an air-pressure generator. Solutions have appeared to disclose an energy-harvesting buoy comprising an air-pressure generator, such as a piezo-electric generator, or any other generator that can harvest energy from an air pressure. The energy harvesting buoy consists of a first float and a second float. An air pressure is created when relative vertical motion occurs between the first float and the second float which drives an air pressurization means such as a piston driven air pump using a linkage member pivotally mounted between the respective floats. The generator uses the air pressure from the air pressurization means to drive the generator to generate electrical power. While claiming in theory to provide energy extraction, by energy-harvesting buoys, such proposed solutions require multiple buoys and have been ineffective.

Some solutions appear to disclose systems for harvesting energy from tidal, wave or current flow in a body of water which comprise an arrangement of first and second pipes with series of spaced holes defining a venturi between the walls of adjacent first and second pipes near the holes; a flow conduit having an inlet and an outlet; an impeller located in the flow conduit; and a generator connected to the impeller. Water from the body can enter the flow conduit via the inlet, and the first pipes are connected to the outlet of the flow conduit such that flow of water past the arrangement of first and second pipes causes the first pipes to act as venturi pumps inducing flow from the inside of the first pipes through the holes so as to draw water through the flow conduit and drive the impeller.

Previous systems for extracting energy from waves used the vertical movement of the water surface caused by the phase shift between the elliptical water particle paths along a wavelength. Typically, previous devices involved some form of float coupled to a mechanical arrangement or some form of trapped air body above the wave surface for converting the periodic vertical movement of the wave surface into some form of motion useful for electricity generation (usually rotary). Such systems are often mechanically complicated and to work effectively are tuned to resonate at a frequency at which the energy density of the ambient wave spectrum is expected to peak. Output can drop dramatically if the wave frequency differs from this design resonant frequency. Such systems are useless if there is only lateral flow (current or tide) with no oscillating vertical wave component.

Systems have been proposed for extracting energy in lateral flows. Such systems have involved the use of a vane which can be caused to oscillate by the flow, a mechanical transmission system converting this into rotary motion. These systems face similar problems to wave-powered systems: mechanical complexity, tuned behavior, unable to extract energy from other types of motion, etc.

Other systems feature a large underwater propeller with an electrical power generator in the hub, analogous to a windmill but for water instead of wind flows. To gain exposure to the maximum incident current energy, the propeller blades have to be very long which in turn requires sophisticated design and materials to accommodate the stresses at the blade root.

Offshore tidal barrages seek to concentrate the incident energy of a large cross-section of water flow by trapping the flow behind a containing wall and funneling it through turbines of much smaller cross-sectional area, as in a conventional dam. Such barrages, typically across a tidal estuary, are very expensive and environmentally disruptive.

One common problem for all these wave or flow systems is to address a sufficiently large cross-section of the ocean for power generation to be possible on an industrial scale. Furthermore, end or edge effects can make it easier for the flow to go around any structure positioned in the flow to extract energy from it rather than to pass through the energy extraction system. This problem can be lessened by making an installation very large but this in turn can lead to further complexity and expense and may lead beyond the limits of current engineering capability.

The common thread between these complicated proposed solutions is that in spite of well-intentioned efforts, water and energy shortages remain commonplace. No effective solutions exist, and effectively addressing future energy needs remains a problem.

The above solutions described are merely intended to be representative of the current state of the art in water energy devices and methods, which, despite various advances, continue to present the need for a system and method for efficiently producing a renewable water-based energy supply, which supply may be distributed based on daily, seasonal, cyclic and/or regional water and energy related demands.

Accordingly, there remains a need for a solution to at least one of the aforementioned problems. For instance, there is an established need for a floating generator that harnesses the energy from ocean waves to produce usable electrical energy. Further there is an established need for such a floating generator that is safe, environmentally friendly, economical and effective.

### SUMMARY OF THE INVENTION

In a first implementation of the present invention a floating water pump apparatus is provided which is capable of using ocean waves to get water to a higher elevation. The floating water pump apparatus comprises a water pump housing operatively connected to a water pump piston, and an exterior float assembly mounted to the water pump housing.

In one aspect, the floating water pump apparatus comprises a water pump housing which has an exterior surface, an upper portion, and a lower portion. The floating water pump apparatus further comprises an exterior float assembly mounted to, or integral with, the exterior surface of the water pump housing. The water pump housing further comprises at least one side wall, a top opening, and a bottom opening, and an interior portion defined thereby. The interior portion comprises a compression chamber. The compression chamber comprises an upper compression chamber and a lower compression chamber. The compression chamber has an upper stop adjacent to the top opening of the water pump housing. The floating water pump apparatus further comprises a compression chamber back valve located in the lower compression chamber. The compression chamber back valve may be any suitable valve. In use, the compression chamber back valve opens when the floating water pump apparatus descends deeper into the water. Then, when the exterior float assembly lifts the compression chamber, the compression chamber back valve closes. The floating water pump apparatus further comprises a water pump piston operatively connected to the water pump housing. The water pump piston has a piston upper portion, a piston intermediate portion and a piston lower portion. The water pump piston comprises a piston shaft with a piston upper opening and a piston flanged lower opening. The water pump piston further comprises a piston back valve located in the piston intermediate portion. The piston back valve may be any suitable valve. The piston back valve is constructed and arranged to only permit water which enters the water pump piston shaft to travel up the piston shaft. In use, the piston shaft will remain vertically oriented relative to the horizontal plane defined by the exterior float assembly. As additional water enters the water pump, water will exit the top of the piston shaft.

In another aspect, the water pump housing may be made of any suitable material, such as, for example without limitation, PVC plastic.

In another aspect, the compression chamber back valve and the piston back valve may be any suitable check valve, for example without limitation, a ball, a ball with a spring, a plate with a hinge, a floating plate or the like. The compression chamber back valve and the piston back valve and components thereof may be made of any suitable materials.

In yet another aspect, the compression chamber back valve may comprise a plate. In some embodiments, the plate may be made of any suitable material, such as, for example without limitation, aluminum. In some embodiments the compression chamber back valve may be pivotally mounted to the compression chamber and may further comprise a hinge.

In another implementation, the present invention is directed to a floating generator system that is capable of harnessing energy from ocean waves to produce usable electrical energy. The present invention is based on the principle that the easiest way to generate electricity is from water falling from a higher elevation. The floating generator system comprises a floating water pump apparatus capable of using ocean waves to get water to a higher elevation, and permitting the water to fall into a hydro-turbine, causing the hydro-turbine to spin, generating electricity.

In one aspect, the present invention provides a floating generator system comprising a floating generator water pump apparatus as described herein, a reservoir, and a hydro-turbine. The reservoir may be supported by a platform. The water which exits the piston shaft of the water pump apparatus will enter the reservoir. As waves thrash, the floating water pump apparatus propels the water into the reservoir. The system may further comprise a water conduit between the water pump apparatus and the reservoir. From the reservoir the water will drop into the hydro-turbine, and then return into the ocean. The operation of the floating water pump apparatus is conceptually similar to the operation of a bicycle pump. A wave descends, and pulls the floating water pump apparatus down, which causes the compression chamber back valve to open, permitting the compression chamber of the floating water pump apparatus to fill with water. As the float causes the apparatus to ascend, the compression chamber back valve closes, causing water to open the piston back valve, permitting water to travel through the piston shaft and up out of the piston shaft into the reservoir. The floating water pump apparatus thereby brings the water to a higher level. Once the water is on a higher level, it travels from the reservoir down to a water conduit tube and to the hydro-turbine. Then the hydro-turbine spins. That action will produce energy. The water is returned to the ocean. The floating water pump apparatus is capable of pumping water all day long.

In a still further aspect, the present invention may comprise a floating desalination system for desalinating ocean saltwater. The floating desalination system may comprise the floating water pump apparatus earlier described, a water conduit with a semi-permeable desalination membrane located therein, and a reservoir for the desalinated water. The reservoir may be supported by a platform. The water which exits the piston shaft will travel through the water conduit and pass through the semi-permeable desalination membrane. After desalination, the water will enter the reservoir. As waves thrash floating water pump apparatus propels the water through the conduit and through the semi-permeable membrane. The water is then propelled into the fresh water reservoir. In use, a wave descends, and pulls the floating water pump apparatus down, which causes the compression chamber back valve to open permitting the compression chamber of the floating water pump apparatus to fill with water. As the float causes the apparatus to ascend, the compression chamber back valve closes, causing water to open the piston back valve permitting water to travel through the piston shaft and up out of the piston shaft into the water conduit and through the semi-permeable membrane. Once the water is desalinated, the desalinated water is conveyed to a purified water reservoir. The water may be retained in the reservoir for use, for bottling or packaging, and for transport. The floating water pump apparatus is capable of pumping water all day long through the floating desalination system powered by waves.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a top isometric view of a water pump apparatus in accordance with a first illustrative embodiment of the present invention;

FIG. 2 presents a bottom isometric view of the water pump apparatus as in FIG. 1;

FIG. 3 presents a side view of the water pump apparatus as in FIG. 1;

FIG. 4 presents a cross-sectional view taken along line 4-4 of FIG. 3, showing the water pump apparatus in a first position, with the compression chamber back valve closed, and the piston shaft back valve closed;

FIG. 5 presents a cross-sectional view as in FIG. 4, showing the water pump apparatus in use in a second position, with the compression chamber back valve open, and the piston shaft back valve closed;

FIG. 6 presents a cross-sectional view as in FIG. 4, showing the water pump apparatus in use in a third position, with the compression chamber back valve closed, and the piston shaft back valve open;

FIG. 7 presents a schematic view of a floating generator system in accordance with a second illustrative embodiment of the present invention;

FIG. 8 presents a schematic view of a floating generator system in accordance with a third illustrative embodiment of the present invention;

FIG. 9 presents a schematic view of the floating generator system as in FIG. 8;

FIG. 10 presents a schematic view of a floating generator system in accordance with an illustrative embodiment of the present invention;

FIG. 11 presents a schematic view of the floating generator system as in FIG. 10;

FIG. 12 presents a top view of the piston of the floating generator system as in FIGS. 8-11;

FIGS. 13A and 13B present schematic views of the floating generator system as in FIGS. 8-11 showing further detail of the piston thereof; and

FIG. 14 presents a schematic view of a floating desalination system in accordance with a fourth illustrative embodiment of the present invention.

Like reference numerals refer to like parts throughout the several views of the drawings.

### DETAILED DESCRIPTION

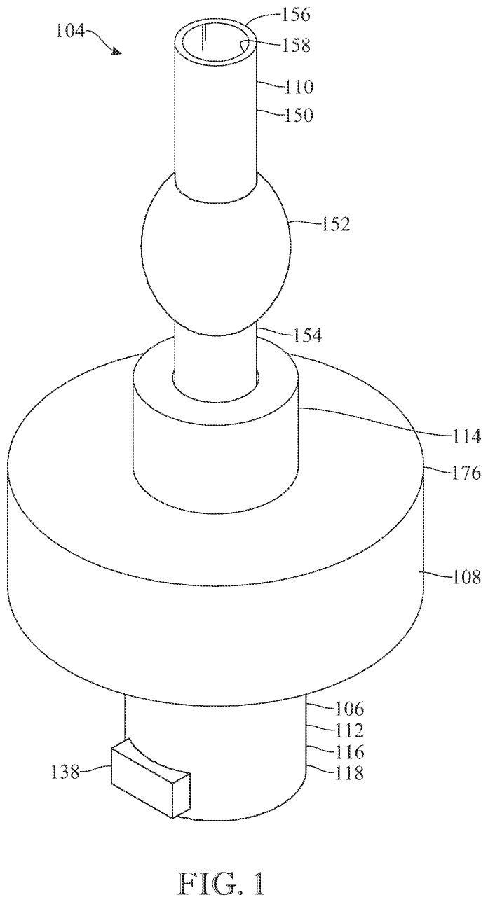

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed to a floating water pump apparatus which is capable of using waves to get water to a higher elevation. The water pump apparatus disclosed herein may be used in any body of water having waves, including oceans, lakes with waves like the Great Lakes, man-made or manufactured bodies of water, or even bodies of water surrounded by sea walls such as intracoastal waterways, to recover energy from any type of waves, from natural waves to manufactured waves, and boat wakes.

The floating water pump apparatus comprises a water pump housing operatively connected to a water pump piston, and an exterior float assembly mounted to the water pump housing.

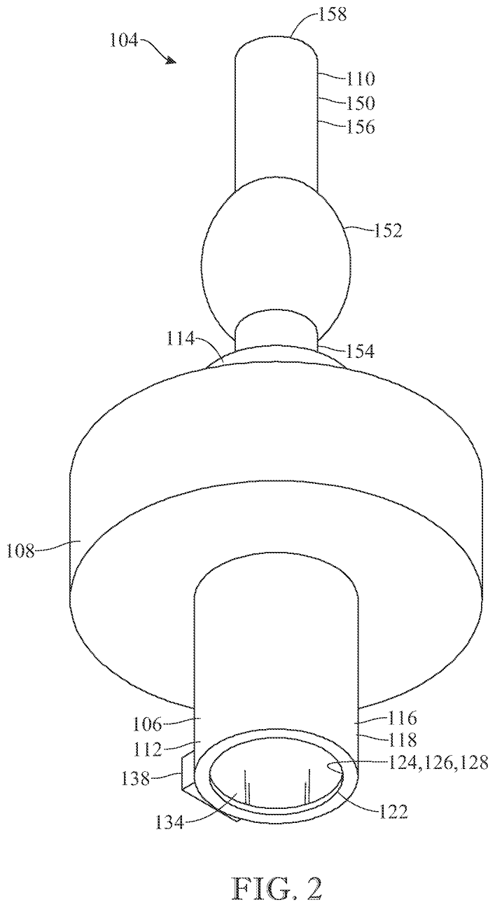

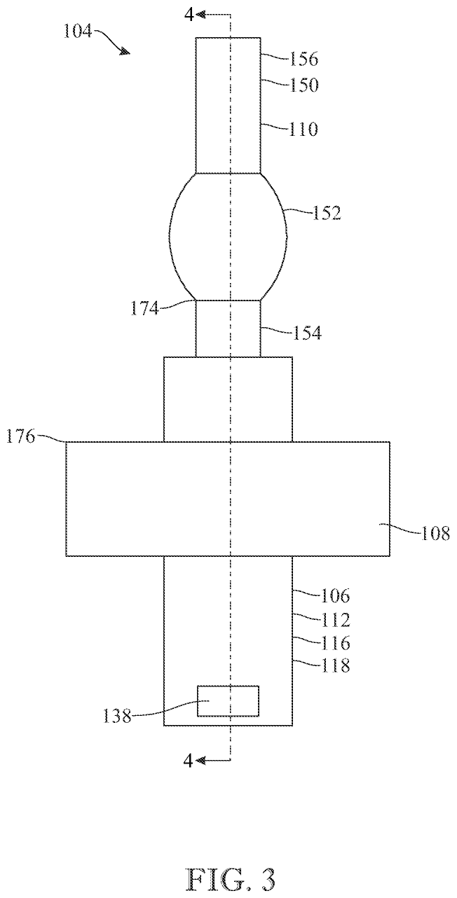

Referring initially to FIGS. 1-6, a floating water pump apparatus, referred to generally at 104, is illustrated in accordance with a first exemplary embodiment of the present invention. As shown for instance in FIG. 1, the floating water pump apparatus 104 comprises a water pump housing 106 which has an exterior surface 112, an upper portion 114, and a lower portion 116. The floating water pump apparatus 104 further comprises an exterior float assembly 108 mounted to the exterior surface 112 of the water pump housing 106. The water pump housing 106 further comprises at least one side wall 118, a top opening 120, and a bottom opening 122, and an interior portion 124 defined thereby. The interior portion 124 comprises a compression chamber 126 having a lower compression chamber 128 and an upper compression chamber 130. The compression chamber 126 has an upper stop 132 adjacent to the top opening 120 of the water pump housing 106. The floating water pump apparatus 104 further comprises a compression chamber back valve 134 located in the lower compression chamber 128. The compression chamber back valve may be any suitable check valve, for example without limitation, a ball, a ball with a spring, a plate with a hinge, a floating plate or the like. The compression chamber back valve and components thereof may be made of any suitable materials. As seen at FIG. 1, the compression chamber back valve 134 may be pivotally mounted to the lower compression chamber 128 by a back valve hinge 136. A back valve hinge housing 138 may extend outwardly from the water pump housing 106 to accommodate the back valve hinge 136.

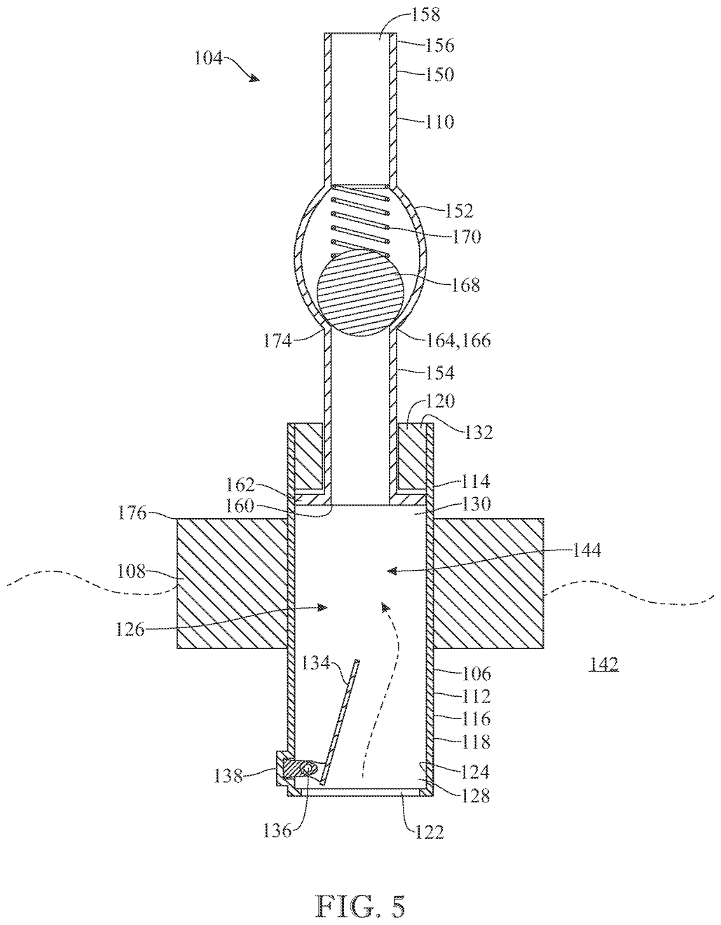

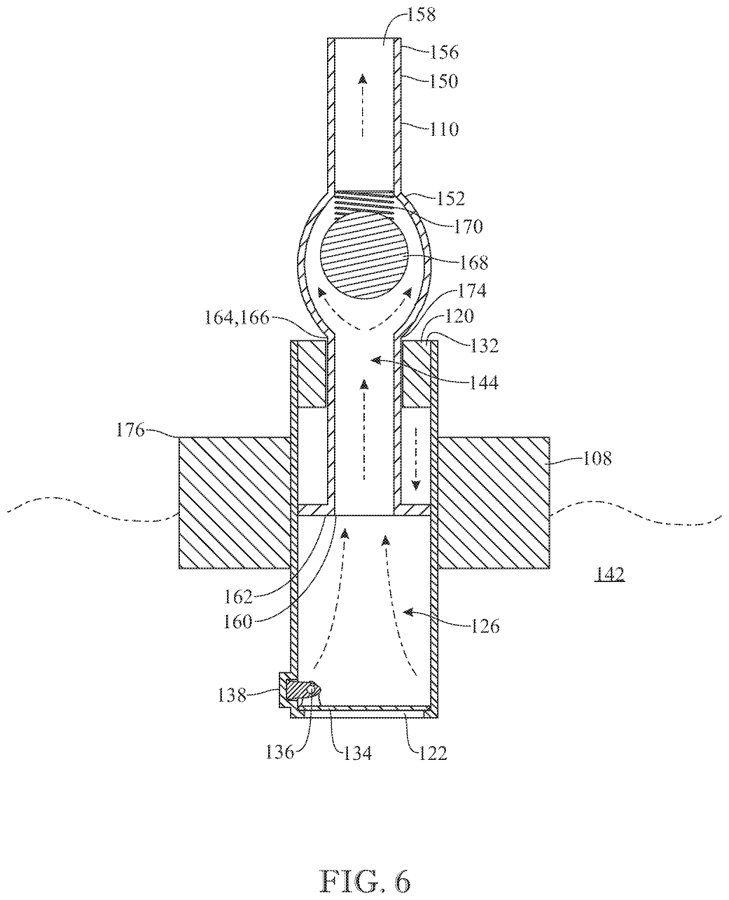

Referring to FIGS. 5-6, in use, the compression chamber back valve 134 opens when the floating water pump apparatus 104 descends deeper into the body of water 142. Then, when the exterior float assembly 108 buoys the floating water pump apparatus 104, lifting the compression chamber 126, the compression chamber back valve 134 closes.

The floating water pump apparatus 104 further comprises a water pump piston 110 operatively connected to the water pump housing 106. The water pump piston 110 has a piston upper portion 150, a piston intermediate portion 152 and a piston lower portion 154. The water pump piston 110 comprises a piston shaft 156 with a piston upper opening 158 and a piston flanged lower opening 160 with a lower flange 162. The lower flange 162 of the piston 110 and the upper stop 132 of the compression chamber 126 are constructed and arranged to limit upward movement of the water pump piston 110 relative to the water pump housing 106 (and limit downward movement of the water pump housing 106 relative to the water pump piston 110). The water pump piston 110 further comprises a piston back valve 164 located in the piston intermediate portion 152. The piston back valve 164 is constructed and arranged to only permit water 144 which enters the water pump piston shaft 156 to travel up the piston shaft 156.

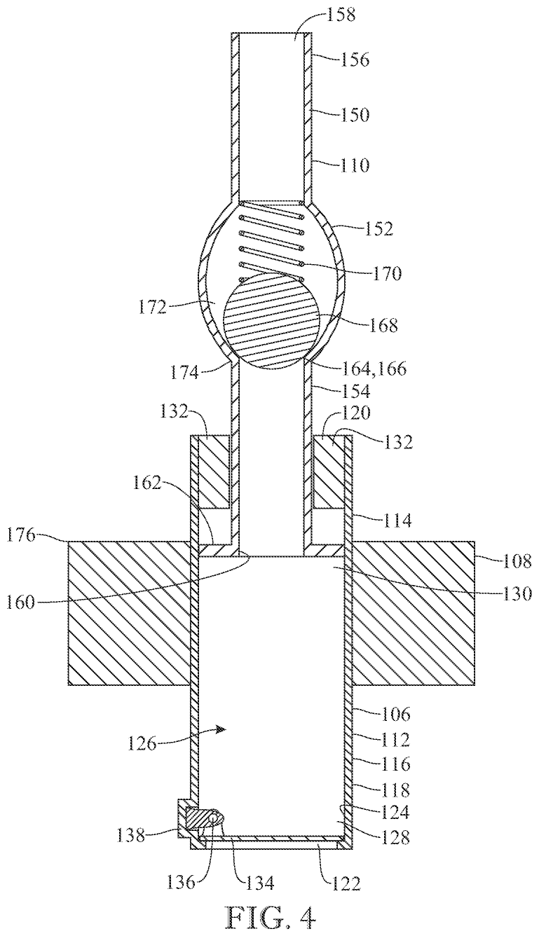

The piston back valve 164 may be any suitable valve means. The piston back valve may be any suitable check valve, for example without limitation, a ball, a ball with a spring, a plate with a hinge, a floating plate or the like. The piston back valve and components thereof may be made of any suitable materials. In an exemplary embodiment, the piston back valve 164 may be a normally closed valve 166 comprising a valve ball 168 and a valve biasing spring 170 which urges the valve ball 168 downward to close the piston shaft 156. This normally closed configuration is best seen at FIGS. 4 and 5. As shown at FIG. 4, the piston intermediate portion 152 is outwardly curved to accommodate and define the piston back valve 164 and provide a back valve interior enclosure 172 configured to accommodate movement of the valve ball 168, and provide an exterior upper limit stop 174 to limit the upward movement of the water pump housing 106 relative to the water pump piston 110. When the exterior float assembly 108 buoys the floating water pump apparatus 104, lifting the compression chamber 136, the compression chamber back valve 134 closes and the water 144 in the compression chamber 136 exerts a water pressure which exceeds the downward force exerted by the valve biasing spring 170, as seen at FIG. 6, causing the valve ball 168 to move upward, permitting the water 144 to flow upward through and out of the piston upper opening 158. When the water pressure no longer exceeds the downward force of the valve biasing spring 170, the valve biasing spring 170 again exerts a downward force on the valve ball 168, causing the valve ball 168 to close the piston back valve 164, thereby preventing water backflow through the piston shaft 156. In use, the piston shaft 156 will remain vertically oriented relative to the horizontal plane 176 defined by the exterior float assembly 108, and perpendicular thereto. As additional water 144 enters the water pump housing 106, the water 144 in the piston shaft 156 will exit the piston upper opening 158.

The floating water pump apparatus 104 and its components may be of any suitable size, shape and dimensions. The water pump housing may have any suitable cross-sectional dimensions or geometric shape, with the water pump piston constructed and arranged to reciprocate within the water pump housing. For example without limitation, and as seen in the figures, the housing 106 and piston 110 may have a circular cross section.

The floating water pump apparatus 104 and its components may be made of any suitable material, fabricated by any suitable fabrication process. In some embodiments, the water pump housing 106 and piston 110 may be made of any suitable material, such as, for example without limitation, PVC plastic. In some embodiments, the exterior float assembly 108 may be made of any suitable buoyant material and may be affixed to the exterior surface 112 of the water pump housing 106 by any suitable means, such as, for example without limitation, a water-resistant adhesive. In other embodiments, the exterior float assembly 108 may be integrally molded with the water pump housing 106 and may be hollow and buoyant.

In some embodiments, the compression chamber back valve and the piston back valve may be any suitable check valve made of any suitable materials. Nonlimiting examples may include a ball, a ball with a spring, a plate with a hinge, a floating plate or the like. In some embodiments of the floating water pump apparatus 104, the compression chamber back valve 134 and back valve hinge 136 may be made of any suitable material, such as, for example without limitation, a metal such as aluminum. It can also be seen that in some embodiments, the compression chamber back valve 134 may be pivotally mounted to the lower compression chamber 128 by any suitable configuration.

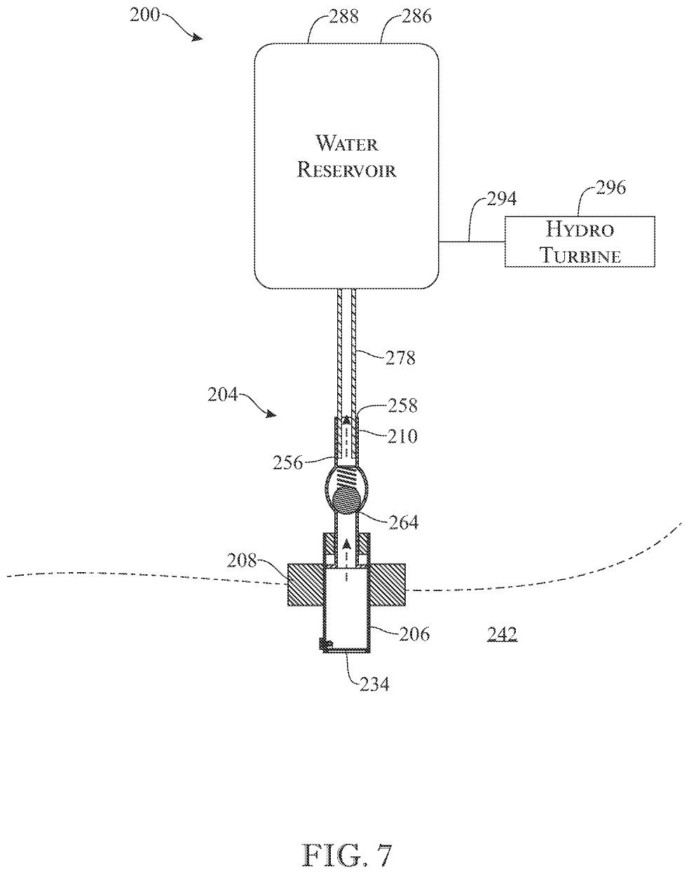

Referring next to FIG. 7, a floating generator system 200 is shown in accordance with a second illustrative embodiment of the invention. Reference numerals which correspond to like elements of the generator water pump apparatus 104 heretofore described with respect to FIGS. 1-6 are designated by the same reference numerals in the 200-299 series in FIG. 7.

The floating generator system 200 comprises a floating generator water pump apparatus 204, a reservoir 286, and a hydro-turbine 296. The system 200 may further comprise a conduit 278 between the pump apparatus 204 and the reservoir 286. In some embodiments the reservoir 286 is a salt water or ocean water reservoir 288.

The structure and function of the components are described hereinabove with respect to FIGS. 1-6. In use, the water 244 will exit the piston upper opening 258 of the generator water pump apparatus 204, and enter the reservoir 286. The reservoir 286 may be supported on any suitable structure such as a platform 292 (not shown). As the waves of the body of water 242 thrash, the generator water pump apparatus 204 is actuated by the waves. The generator pump apparatus 204 propels the water 244 from the generator water pump apparatus 204 into the reservoir 286. As seen at FIG. 7, the generator water pump apparatus 204 may convey the water 244 through the conduit 278 between the pump apparatus 204 and the reservoir 286. In some embodiments, the floating generator system 200 may not have the conduit 278 between the pump apparatus 204 and the reservoir 286, and may simply throw water 244 from the generator water pump apparatus 204 into the reservoir 286.

From the reservoir 286, the water 244 will be conveyed to the hydro-turbine 296. In some embodiments, the water 244 will be conveyed by a conduit 294 between the reservoir 286 and the hydro-turbine 296. In other embodiments, the water 244 will simply drop from the reservoir 286 into the hydro-turbine 296. From the hydro-turbine 296, the water will return into the body of water 242 (ocean). The operation of the floating generator water pump apparatus 204 is conceptually similar to the operation of a bicycle pump. A wave in the body of water 242 descends, and pulls the floating generator water pump apparatus 204 downward, which causes the compression chamber back valve 234 to open, permitting the water 244 from the body of water 242 to enter and fill the compression chamber 226 of the floating generator water pump apparatus 204 with the water 244. As the exterior float assembly 208 causes the floating generator water pump apparatus 204 to ascend in the body of water 242, the compression chamber back valve 234 closes, causing the water 244 to open the piston back valve 264, permitting the water 244 to travel through the piston shaft 256 and up out of the piston upper opening 258 by a water conduit 278 into the reservoir 286. The floating generator water pump apparatus 204 thereby brings the water 244 to a higher level, in the reservoir 286. Once the water 244 is at a higher level, in the reservoir 286, the water 244 travels from the reservoir 286 down to a water conduit tube 294 and to the hydro-turbine 296. Then the hydro-turbine 296 spins and that action will produce energy. The water 244 is returned from the hydro-turbine 2% to the ocean 242. The floating generator water pump apparatus 204 is capable of pumping water all day long. The floating generator system 200 and its components may be of any suitable size, shape and dimensions, and may be made of any suitable material, fabricated by any suitable fabrication process.

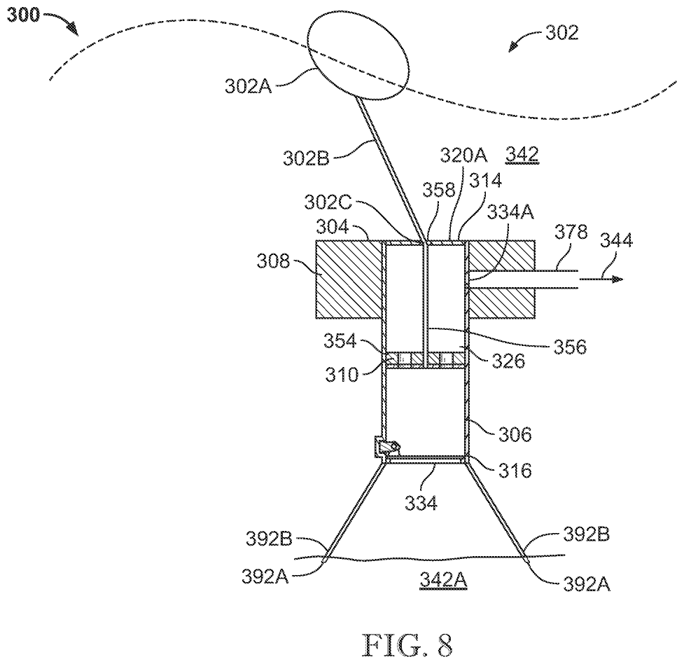

Referring next to FIGS. 8-12 and 13A-B, a generator system 300 is shown in accordance with a third illustrative embodiment of the invention. Reference numerals which correspond to like elements of the generator water pump apparatus 104 heretofore described with respect to FIGS. 1-6, and the floating generator water pump apparatus 204 heretofore described with respect to FIG. 7, are designated by the same reference numerals in the 300-399 series in FIGS. 8-12 and 13A-B. The function of the components are as described hereinabove with respect to FIGS. 1-6, and FIG. 7, though the arrangement and location of the components may differ.

Also seen at FIGS. 8-12 and 13A-B, the generator system 300 comprises a generator water pump apparatus 304, and a support and positioning system having an upper portion and a lower portion.

The generator system 300 may be located in any body of water 342. For example, the generator system 300 may be used in an ocean, but may also be used in other bodies of water which have large waves. As noted herein above regarding other embodiments, the generator system 300 and water pump apparatus 304 may be used in any body of water having waves, including oceans, lakes with waves like the Great Lakes, man-made or manufactured bodies of water, or even bodies of water surrounded by sea walls such as intracoastal waterways, to recover energy from any type of waves, from natural waves to manufactured waves, and boat wakes.

As shown at FIGS. 8-11 and 13A-B, the support and positioning system upper portion comprises a system upper float assembly 302. The system upper float assembly 302 comprises at least one upper float 302A and at least one upper float suspension line or cable 302B configured to be connected to the generator water pump apparatus 304. An upper float suspension line or cable 302B may be connected to the housing 306 at the upper portion 314 of the generator water pump apparatus 304 by any suitable means, such as, for example without limitation, securement to an upper float assembly cable receiver 302C.

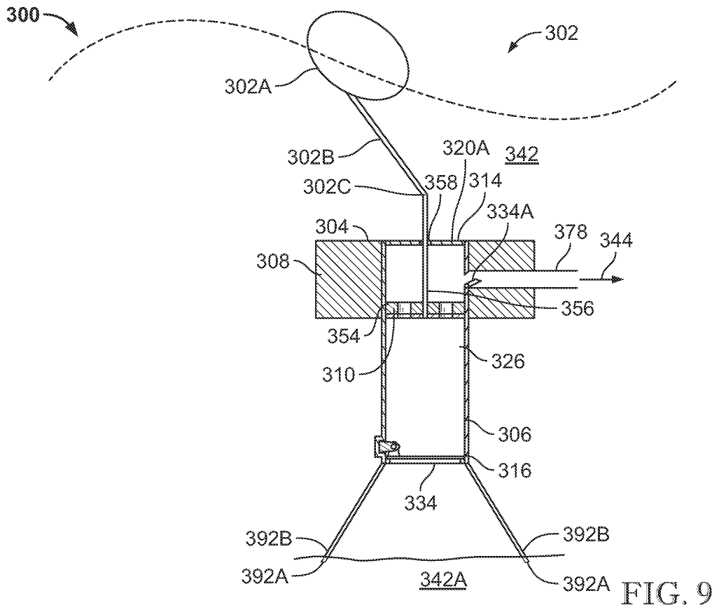

As shown at FIGS. 8-9, in some embodiments, the upper float suspension line or cable 302B may be connected to the piston shaft 356 (described further hereinbelow) by the upper float assembly cable receiver 302C. In some embodiments, the piston shaft and the upper float suspension line or cable 302B and the piston shaft 356 may be a single integral unit, such that the piston lower portion 354 may be connected directly to the upper float 302A by the combined upper float suspension line or cable and piston shaft 302B/356. The upper float suspension line or cable 302B and the piston shaft 356 may comprise an “attachment” of any type, such as, for example without limitation, a steel cable, a shaft with a chain, or even a nylon-like fishing wire, which is capable of supporting the piston heavy plate 354A.

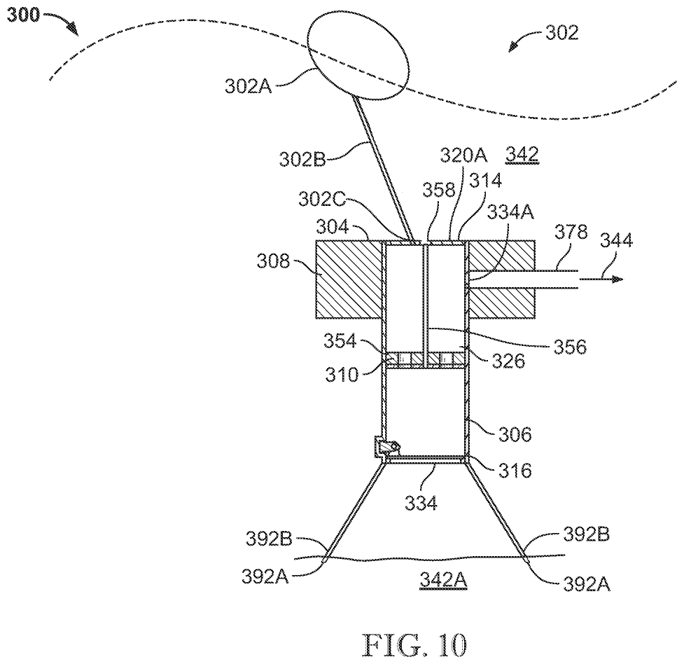

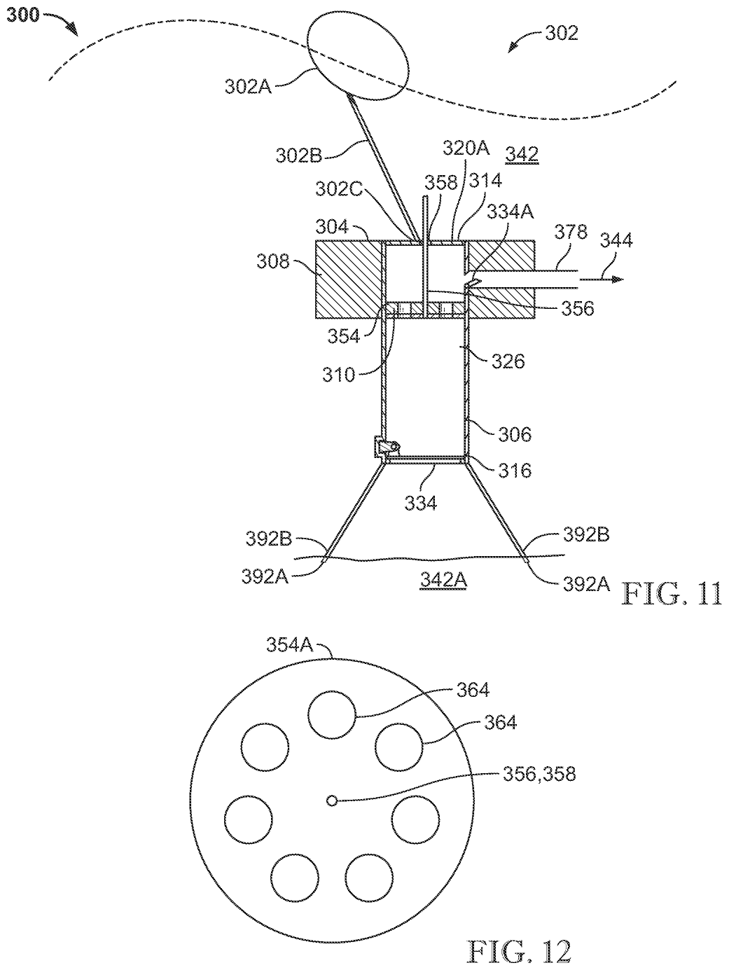

As shown at FIGS. 10-11, in other embodiment, the upper float suspension line or cable 302B may be connected to an upper float assembly cable receiver 302C provided on or in the cover 320A of the generator water pump apparatus 304. The cover 320A may include the float assembly cable receiver 302C being attached thereto or integrally formed therewith.

The support and positioning system lower portion comprises at least one system anchor assembly 392. The at least one system anchor assembly 392 may comprise an anchor 392A and an anchor line or cable 392B. A plurality of system anchor assemblies may be provided. For example, as seen at FIGS. 8-11, two system anchor assemblies 392, comprising two anchors 392A and two anchor lines 392B may be provided. An anchor line or cable 392B may be secured to the housing 306 at the lower portion 316 of the generator water pump apparatus 304 by any suitable means, such as for example without limitation, a mechanical connector or an adhesive.

Also seen at FIG. 8-11, the generator water pump apparatus 304 is supported by the upper float assembly 302, and may be supported by or anchored to the floor 342A of the body of water by anchor assemblies 392.

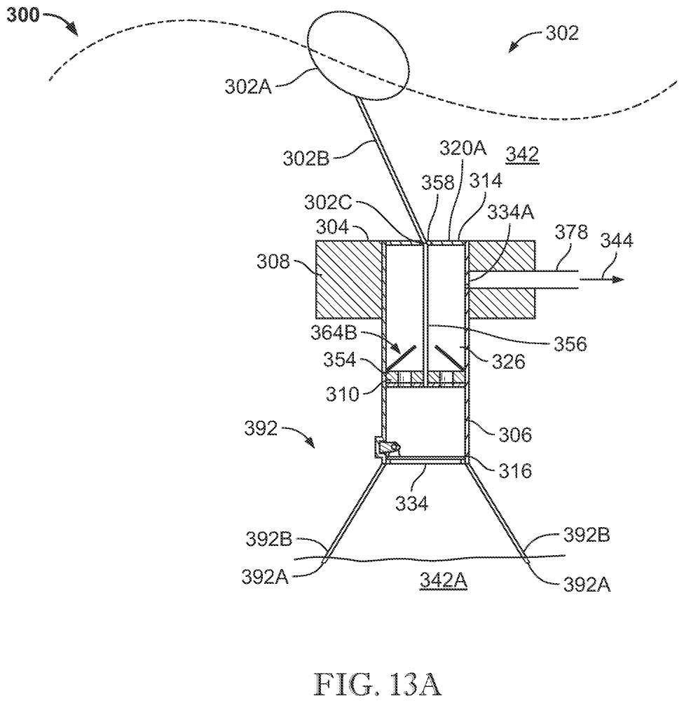

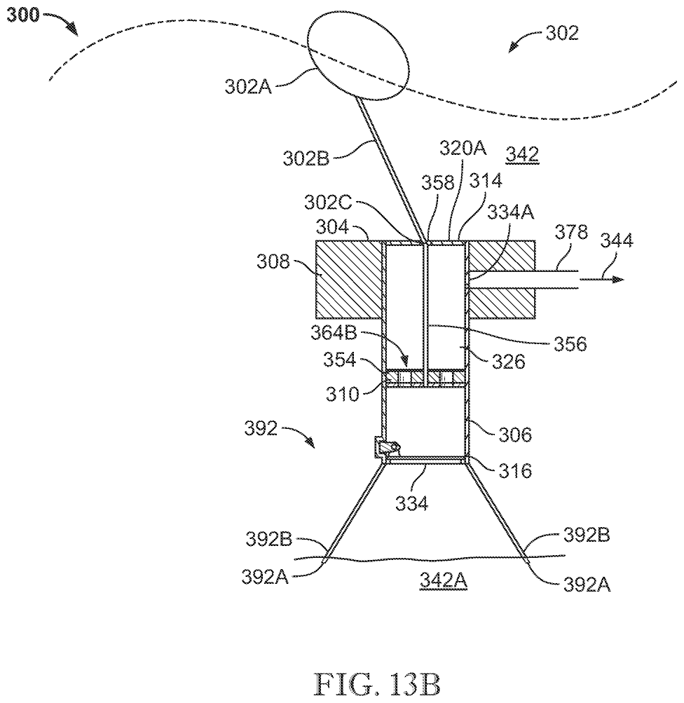

Referring to FIGS. 8-11 and 13A-B, the generator water pump apparatus 304 includes a piston 310 having a piston lower portion 354 which comprises a piston heavy plate 354A, operably connected to a piston shaft 356. At FIG. 12, a top view of the piston is shown, and at FIGS. 13A-B further details of the piston structure are shown. The piston heavy plate 354A may have any suitable weight, that enables the piston heavy plate 354A to remain in a first lower position (as seen at FIGS. 8 and 10), further permits the piston heavy plate 354A to be displaced from the first lower position and to be raised to a second elevated position (as seen at FIG. 9 and FIG. 11) by the operation of the generator water pump apparatus 304 and upward movement of the exterior float assembly 308 in response to waves in the body of water 342, and then enables the piston heavy plate 354A to descend to the first lower position as water flows out of the generator water pump apparatus 304.

The piston lower portion 354 may further comprise at least one piston back valve 364, which may comprise a back valve system incorporated with the piston heavy plate 354. As seen more particularly at FIG. 12, a plurality of spaced piston check valves 364A may be provided on the heavy plate 354, which may be arranged radially with respect to the piston shaft 356. As shown at FIGS. 13A-B, a piston check valve cover assembly 364B may comprise two cover portions pivotally mounted to an upper surface of the piston heavy plate 354A at diametrically opposite locations on the upper surface of the piston heavy plate 354A.

The piston shaft 356 may comprise an “attachment” of any type, such as, for example without limitation, a steel cable, a shaft with a chain, or even a nylon-like fishing wire. The piston shaft 356 is configured to support the piston heavy plate 354A.

The piston shaft 356 may extend through a piston opening 358 in the cover 320A at the top of the housing 306 so the elevation of the float assembly 308 in response to waves may cause the piston 310 to be elevated, and as the float descends the weight of the piston heavy plate 354A enables the piston 310 to descend to the housing lower portion 316. With reference to FIGS. 13A-B, as the piston ascends, the piston check valve cover assembly 364B may close to enable the piston to propel water 344 from the compression chamber out the water conduit (or water flow pipe) 378 in fluid communication with the compression chamber 326. As the piston 310 descends, the piston check valve cover assembly 364B may open so that more water may be taken into the compression chamber 326.

In alternative embodiments the piston shaft 356 may be made of a flexible material, the piston shaft 356 may be connected to a lower surface of the cover 320A and be configured to support the piston heavy plate 354A in the water pump housing 306, such that the piston shaft 356 may support the piston heavy plate 354A in its first lower position, and then the piston shaft 356 may simply deform or bend as the piston 310 is elevated, and as the float descends the weight of the piston heavy plate 354A enables the piston to descend to the housing lower portion 316 again suspended from the cover 320A and supported by the piston shaft 356 so that more water may be taken into the compression chamber 326.

As the waves of the body of water 342 thrash, the generator water pump apparatus 304 is actuated by the waves. As shown at FIGS. 8-11 and 13A-B, the generator water pump apparatus 304 may convey the water 344 through the compression chamber 326 to the water conduit (or water flow pipe) 378.

In alternative embodiments, the floating generator system may not have a compression chamber or conduit, and may simply throw water from the generator water pump apparatus 304 into the body of water 342.

Referring again to FIGS. 8-11 and 13A-B, in use, the water 344 will exit the generator water pump apparatus 304 to a water conduit (or water flow pipe) 378. The compression chamber upper back valve 334A is in fluid communication with a water conduit (or water flow pipe) 378. The compression chamber upper back valve 334A may be any suitable check valve as described herein.

As seen at FIGS. 8-11 and 13A-B, the generator water pump apparatus 304 may convey the water 344 through the conduit or compression chamber 326. At the upper portion 314 of the water pump housing 306, the compression chamber 326 includes a compression chamber upper back valve 334A configured to open and permit the water pump apparatus 304 to convey the water 344 into a water conduit (or water flow pipe) 378. The water conduit 378 may be a manifold system or pipeline. In operation of the water pump apparatus 304, the compression chamber upper back valve 334A opens (best seen at FIG. 9 and FIG. 11) to permit the water to flow out of the pump apparatus into the water conduit 378, and then the compression chamber upper back valve 334A returns to its normally closed position to prevent the water in the water conduit 378 or downstream therefrom from flowing back into the compression chamber 326. The compression chamber upper back valve 334A may be any suitable valve, such as, for example without limitation, a hinged valve.

The operation of the floating generator water pump apparatus 304 is conceptually similar to the operation of a bicycle pump. A wave in the body of water 342 descends, and pulls the generator water pump apparatus 304 downward, causing the compression chamber lower back valve 334 to open, permitting the water 344 from the body of water 342 to enter and fill the compression chamber 326 of the floating generator water pump apparatus 304 with the water 344. As the exterior float assembly 308 causes the piston 310 to ascend, the water 344 is permitted to travel out of the compression chamber upper valve 334A and to the water flow pipe (or water conduit) 378.

The generator water pump apparatus 304 thereby conveys the water 344 through the water flow pipe (or water conduit) 378, manifold system or pipeline and to a higher level, as described herein. Once the water 344 is at a higher level, the water 344 may be returned to the body of water 342, producing energy.

The generator water pump apparatus 304 is capable of pumping water all day long. The generator system 300 and its components may be of any suitable size, shape and dimensions, and may be made of any suitable material, fabricated by any suitable fabrication process.

In some embodiments, the floating generator system may not have a conduit or compression chamber, and may simply throw water from the generator water pump apparatus into the body of water.

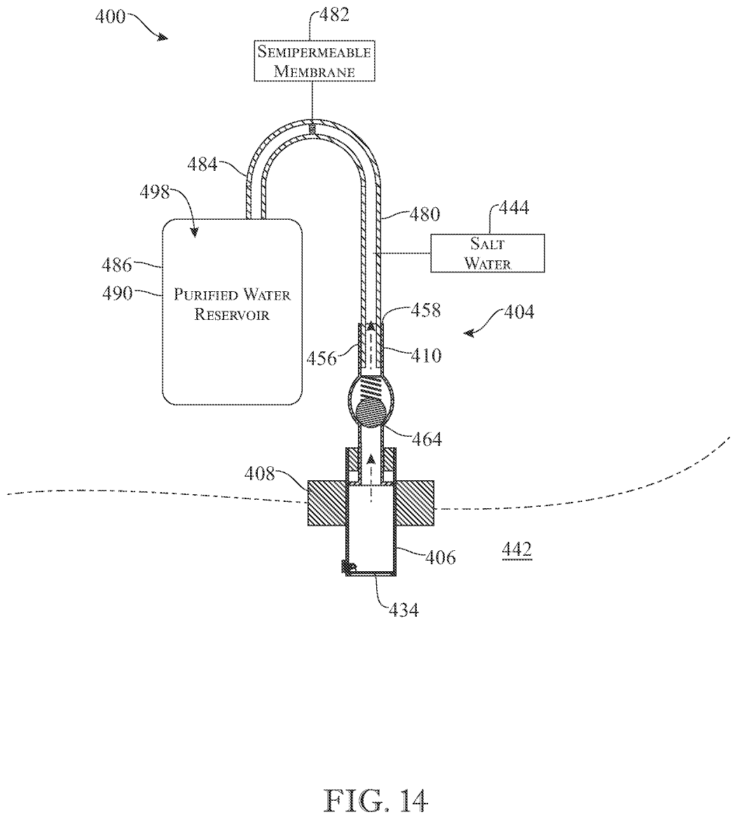

Referring next to FIG. 14, a floating desalination system 400 for desalinating ocean saltwater 444 is shown in accordance with a fourth illustrative embodiment of the invention. Reference numerals which correspond to like elements of the water pump apparatus 104 heretofore described with respect to FIGS. 1-6, the floating generator water pump apparatus 204 heretofore described with respect to FIG. 7, and the floating generator water pump apparatus 304 heretofore described with respect to FIGS. 8-12 and 13A-B are designated by the same reference numerals in the 400-499 series in FIG. 14. The floating desalination system 400 for desalinating ocean saltwater 444 may comprise the floating water pump apparatus 404 as earlier described. The floating desalination system 400 may further comprise a proximal water conduit 480, a semi-permeable desalination membrane 482, a distal water conduit 484, and a reservoir 486. The reservoir 486 may be a purified water reservoir 490. Ocean water may be conveyed from the floating water pump apparatus 404 via the proximal water conduit 480 to the semipermeable desalination membrane 482. After passing through the semipermeable desalination membrane, desalinated purified water 498 is conveyed through the distal water conduit 484 to the purified water reservoir 490. The purified water reservoir 490 may be supported by a platform 492 (not shown).

The water 444 which exits the piston upper opening 458 of the piston shaft 456 will travel through the proximal water conduit 480 and pass through the semi-permeable desalination membrane 482. After desalination, the desalinated water 498 will enter the purified water reservoir 496 for storage therein. As waves thrash, the floating water pump apparatus 404 propels the water through the proximal water conduit 480 and through the semi-permeable membrane 482. The purified water 498 is then propelled into the purified water reservoir 490. In use, a wave descends, and pulls the floating water pump apparatus down, which causes the compression chamber back valve to open permitting the compression chamber of the floating water pump apparatus to fill with water. As the float assembly 408 causes the apparatus 404 to ascend, the compression chamber back valve 434 closes, causing water to open the piston back valve 464, permitting water 444 to travel through the piston shaft 456 and up out of the piston upper opening 458 into the proximal water conduit 480 and through the semi-permeable membrane 482. Once the salt water 444 is desalinated, the desalinated water 498 is conveyed through the distal water conduit 484 to the purified water reservoir 490, and held in the purified water reservoir 490 for use, for bottling or packaging, and for transport. The floating water pump apparatus 404 is capable of pumping water all day long through the floating desalination system 400 in response to ocean waves.

The floating desalination system 400 and its components may be of any suitable size, shape and dimensions, and may be made of any suitable material, fabricated by any suitable fabrication process.

In summary, in an exemplary embodiment, the present invention provides a wave-powered floating water pump apparatus comprising a pump housing, a piston and an exterior float. The pump housing comprises a housing upper portion, a housing lower portion, a housing interior portion and a housing exterior portion. The housing interior defines a compression chamber. A compression chamber back valve is located in the compression chamber at the housing lower portion, at a lowermost portion of the wave-powered floating water pump apparatus. The piston is operatively connected to the housing for reciprocation therein. The piston comprises a piston lower opening, a piston upper opening, and a piston shaft in fluid communication with the compression chamber, the piston upper opening being located at an uppermost portion of the wave-powered floating water pump apparatus. A piston back valve is located in the piston shaft. The compression chamber back valve is constructed and arranged to open when the wave-powered floating water pump apparatus descends in the ocean, permitting a quantity of water to enter the compression chamber through the compression chamber back valve, and to close when the exterior float lifts the wave-powered floating water pump apparatus. The piston back valve is constructed and arranged to open in response to the quantity of water entering the compression chamber, permitting the quantity of water to enter the piston shaft, the piston back valve being further constructed and arranged to permit the quantity of water which enters the piston shaft to exit only from the piston upper opening. The quantity of water enters the wave-powered floating water pump apparatus by the compression chamber back valve at the lowermost portion of the wave-powered floating water pump apparatus, and exits the wave-powered floating water pump apparatus at the piston upper opening at the uppermost portion of the wave-powered floating water pump apparatus, thereby exiting the wave-powered floating water pump at a higher elevation.

A floating generator system for harnessing energy from ocean waves to produce usable electrical energy may include the wave-powered floating water pump apparatus as described herein, and may further include a water storage reservoir and a hydro-turbine located at a lower elevation relative to the wave-powered floating water pump apparatus and the water storage reservoir. Water may fall from the wave-powered floating water pump apparatus, the water storage reservoir, or combinations thereof to generate usable electrical energy.

A system for purifying and desalinating ocean water may include the wave-powered floating water pump apparatus as described herein, and may further include a purified water reservoir and a water conduit in fluid communication with the wave-powered floating water pump and the purified water reservoir. The water conduit may comprise a first end in fluid communication with the piston upper opening of the wave-powered floating water pump apparatus, an intermediate portion, and a second end in fluid communication with the purified water reservoir. A semi-permeable reverse osmosis membrane may be located at the intermediate portion of the water conduit. In response to a quantity of water being pumped from the wave-powered floating water pump apparatus through the water conduit, the quantity of water will pass through the semi-permeable reverse osmosis membrane, and the resulting quantity of purified water will be conveyed to the purified water reservoir.

In another embodiment, a wave-powered water pump apparatus for use in a body of water comprises a pump housing, a cover, an exterior pump float, a compression chamber upper back valve, a compression chamber lower back valve, a piston and at least one piston back valve. The pump housing comprises a housing upper portion, a housing lower portion, a housing interior portion and a housing exterior portion, the housing interior defining a compression chamber. The exterior pump float is operatively connected to the pump housing for vertical reciprocal movement on the housing exterior portion between the housing upper portion and the housing lower portion. The compression chamber lower back valve located in the compression chamber at the housing lower portion, at a lowermost portion of the wave-powered floating water pump apparatus. The compression chamber upper back valve located in the compression chamber at the housing upper portion. The piston comprises a piston shaft and a piston heavy plate. The piston is operatively connected to the housing for reciprocation therein. The at least one piston back valve is located on the piston heavy plate and is in fluid communication with the compression chamber. The compression chamber lower back valve is constructed and arranged to open when the wave-powered water pump apparatus descends in the body of water, permitting a quantity of water to enter the compression chamber through the compression chamber lower back valve, and to close when the exterior float lifts the wave-powered water pump apparatus. The at least one piston back valve is constructed and arranged to open in response to the piston ascending to permit the quantity of water to flow therethrough, and to close in response to the piston descending. The compression chamber upper back valve is constructed and arranged to open in response to the quantity of water entering the compression chamber, the compression chamber upper back valve being further constructed and arranged to permit the quantity of water which enters the compression chamber to exit the compression chamber only from the compression chamber upper back valve. The quantity of water which enters the wave-powered water pump apparatus by the compression chamber lower back valve at the lowermost portion of the wave-powered water pump apparatus, flows through at least one piston back valve and exits the wave-powered water pump apparatus at the compression chamber upper back valve. The wave-powered water pump apparatus may be used on its own. The wave-powered water pump apparatus may further be incorporated in a floating generator system. The wave-powered water pump apparatus may further be incorporated in a system for purifying and desalinating water as described herein.

A floating generator system for harnessing energy from waves of a body of water to produce usable electrical energy comprises the wave-powered water pump apparatus, and a support and positioning system having an upper portion and a lower portion, the support and positioning system being configured for attachment to the pump housing for placement and retention of the wave-powered water pump apparatus.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A wave-powered floating water pump apparatus comprising:
a pump housing comprising a housing upper portion, a housing lower portion, a housing interior portion and a housing exterior portion, the housing interior defining a compression chamber;
a compression chamber back valve located in the compression chamber at the housing lower portion, at a lowermost portion of the wave-powered floating water pump apparatus;
a piston operatively connected to the housing for reciprocation therein, the piston comprising a piston lower opening, a piston upper opening, and a piston shaft in fluid communication with the compression chamber, the piston upper opening being located at an uppermost portion of the wave-powered floating water pump apparatus;
a piston back valve located in the piston shaft; and
an exterior float located on the housing exterior portion;
wherein, the compression chamber back valve is constructed and arranged to open when the wave-powered floating water pump apparatus descends in the ocean, permitting a quantity of water to enter the compression chamber through the compression chamber back valve, and to close when the exterior float lifts the wave-powered floating water pump apparatus; and
wherein, the piston back valve is constructed and arranged to open in response to the quantity of water entering the compression chamber, permitting the quantity of water to enter the piston shaft, the piston back valve being further constructed and arranged to permit the quantity of water which enters the piston shaft to exit only from the piston upper opening;
whereby the quantity of water which enters the wave-powered floating water pump apparatus by the compression chamber back valve at the lowermost portion of the wave-powered floating water pump apparatus, and exits the wave-powered floating water pump apparatus at the piston upper opening at the uppermost portion of the wave-powered floating water pump apparatus, thereby exits the wave-powered floating water pump at a higher elevation.

2. The water pump apparatus of claim 1 wherein the exterior float is mounted to the exterior surface of the pump housing.

3. The water pump apparatus of claim 2 wherein the pump housing further comprises at least one side wall, a top opening, and a bottom opening.

4. The water pump apparatus of claim 3 wherein the compression chamber comprises a lower compression chamber, and an upper compression chamber.

5. The water pump apparatus of claim 4 wherein the compression chamber further comprises an upper stop adjacent to the top opening of the pump housing.

6. The water pump apparatus of claim 5 wherein the compression chamber back valve comprises a check valve selected from a ball, a ball with a spring, a plate with a hinge, or a floating plate.

7. The water pump apparatus of claim 6 wherein the compression chamber back valve comprises a plate with a hinge, and the compression chamber back valve is pivotally mounted to the lower compression chamber by a back valve hinge.

8. The water pump apparatus of claim 7 wherein the pump housing further comprises a back valve hinge housing extending outwardly from the water pump housing to accommodate the back valve hinge.

9. A floating generator system for harnessing energy from ocean waves to produce usable electrical energy, the system comprising in combination:
a wave-powered floating water pump apparatus as in claim 1;
a water storage reservoir; and
a hydro-turbine located at a lower elevation relative to the wave-powered floating water pump apparatus and the water storage reservoir;
whereby, water may fall from the wave-powered floating water pump apparatus, the water storage reservoir, or combinations thereof to generate usable electrical energy.

10. A system for purifying and desalinating water, the system comprising in combination:
a wave-powered floating water pump apparatus as in claim 1;
a purified water reservoir;
a water conduit comprising:
a first end in fluid communication with the piston upper opening of the wave-powered floating water pump apparatus;
an intermediate portion; and
a second end in fluid communication with the purified water reservoir; and
a semi-permeable reverse osmosis membrane located at the intermediate portion of the water conduit;
whereby, in response to a quantity of water being pumped from the wave-powered floating water pump apparatus through the water conduit, the quantity of water will pass through the semi-permeable reverse osmosis membrane, and the resulting quantity of purified water will be conveyed to the purified water reservoir.

11. A wave-powered water pump apparatus for use in a body of water, the wave-powered water pump apparatus comprising:
a pump housing comprising a housing upper portion, a housing lower portion, a housing interior portion and a housing exterior portion, the housing interior defining a compression chamber;
a cover;
an exterior pump float operatively connected to the pump housing for vertical reciprocal movement on the housing exterior portion between the housing upper portion and the housing lower portion;
a compression chamber lower back valve located in the compression chamber at the housing lower portion, at a lowermost portion of the wave-powered floating water pump apparatus;
a compression chamber upper back valve located in the compression chamber at the housing upper portion;
a piston operatively connected to the housing for reciprocation therein, the piston comprising a piston shaft and a piston heavy plate; and
at least one piston back valve located on the piston heavy plate and in fluid communication with the compression chamber;
wherein, the compression chamber lower back valve is constructed and arranged to open when the wave-powered water pump apparatus descends in the body of water, permitting a quantity of water to enter the compression chamber through the compression chamber lower back valve, and to close when the exterior float lifts the wave-powered water pump apparatus;
wherein, the at least one piston back valve is constructed and arranged to open in response to the piston ascending to permit the quantity of water to flow therethrough, and to close in response to the piston descending; and
wherein, the compression chamber upper back valve is constructed and arranged to open in response to the quantity of water entering the compression chamber, the compression chamber upper back valve being further constructed and arranged to permit the quantity of water which enters the compression chamber to exit the compression chamber only from the compression chamber upper back valve;
whereby the quantity of water which enters the wave-powered water pump apparatus by the compression chamber lower back valve at the lowermost portion of the wave-powered water pump apparatus, flows through at least one piston back valve and exits the wave-powered water pump apparatus at the compression chamber upper back valve.

12. The water pump apparatus of claim 11 wherein the compression chamber lower back valve comprises a check valve selected from a ball, a ball with a spring, a plate with a hinge, or a floating plate.

13. The water pump apparatus of claim 12 wherein the compression chamber lower back valve comprises a plate with a hinge, and the compression chamber back valve is pivotally mounted to the lower compression chamber by a back valve hinge.

14. The water pump apparatus of claim 11 wherein the pump housing further comprises a back valve hinge housing extending outwardly from the water pump housing to accommodate the back valve hinge.

15. A floating generator system for harnessing energy from waves of a body of water to produce usable electrical energy, the system comprising in combination:
a wave-powered water pump apparatus as in claim 11;
a support and positioning system having an upper portion and a lower portion, the support and positioning system being configured for attachment to the pump housing for placement and retention of the wave-powered water pump apparatus.

16. A floating generator system as in claim 15 wherein:
the support and positioning system upper portion comprises at least one upper float and at least one upper float cable; and
the support and positioning system lower portion comprises at least one anchor and at least one anchor cable;
wherein the at least one upper float is configured to float on a surface of the body of water and the at least one upper float cable extends between the at least one upper float and the housing upper portion;
wherein the at least one anchor is supported by and extends into a floor of the body of water and the at least one anchor cable extends between the at least one anchor and the housing lower portion.

17. A system for purifying and desalinating water, the system comprising in combination:
a wave-powered floating water pump apparatus as in claim 11;
a purified water reservoir;
a water conduit comprising:
a first end in fluid communication with the piston upper opening of the wave-powered floating water pump apparatus;
an intermediate portion; and
a second end in fluid communication with the purified water reservoir; and
a semi-permeable reverse osmosis membrane located at the intermediate portion of the water conduit;
whereby, in response to a quantity of water being pumped from the wave-powered floating water pump apparatus through the water conduit, the quantity of water will pass through the semi-permeable reverse osmosis membrane, and the resulting quantity of purified water will be conveyed to the purified water reservoir.
